(19) United States
(12) Patent Application Publication
(10) Pub. No.: US 2013/0068853 A1
(43) Pub. Date: Mar. 21, 2013

(54) Programmable Spray Device and Spray Method Thereof

(71) Applicant: Hsiung Hsiao, Hsinchu City (TW)

(72) Inventor: Hsiung Hsiao, Hsinchu City (TW)

(73) Assignee: MIDDLELAND SENSING TECHNOLOGY, INC., Hsinchu City (TW)

(21) Appl. No.: 13/610,521

(22) Filed: Sep. 11, 2012

(30) Foreign Application Priority Data
Sep. 15, 2011 (TW) 100133296

(51) Int. Cl. B05B 17/04; B05B 17/06

(52) U.S. Cl. 239/11; 239/69

(57) ABSTRACT

A programmable spray device that is portable and its spray method. The programmable spray device includes a plurality of spray modules and a control module. Each spray module is used to contain different fluids. The control module is used to receive a control signal outputted from a processing device, and to control each spray module to spray according to the control signal. The processing device includes a multimedia play module generating the control signal while playing a multimedia content, and the control module controls each spray module to execute variations of spraying coordinated to the multimedia content.

### CROSS-REFERENCE TO RELATED APPLICATION

This application claims the benefit of Taiwan Patent Application No. 100133296, filed on Sep. 15, 2011, in the Taiwan Intellectual Property Office, the disclosure of which is incorporated herein in its entirety by reference.

### BACKGROUND OF THE INVENTION

1. Field of the Invention

The present invention relates to a programmable spray device and its spray method, and more particularly to a programmable spray device that is portable and its spray method capable of being controlled by a computer so that a sprayer can produce different types of spraying variation at various time points.

2. Description of the Related Art

In recent years, many types and kinds of spray devices are in the market, and fields applied by each spray device are also different based upon its design and the substances it is filled with. For example, the spray device can be taken as a fragrance in toilets, a medicine spray for medical treatment, and a cleaning spray for daily life. Further, the spray device can be developed to achieve automatic control for performing the spraying motion from the initial manual control of the past.

Most companies focus on spray control to improve the spray devices so that the spray time or spray quantity of the spray device can be precisely controlled in a fully automatic or semi-automatic manner to precisely control the spray duration and spray volumn as well as to allow the spray device to perform spraying at fixed times with fixed quantity. The foregoing improvements merely improve the structure in the spray device or programs controlled by the computer, and its effect merely allows the spray device to achieve single spray effect without spray variation and flexibility.

For the foregoing reasons, if the spray device can be improved, and any electronic device for controlling the spray device can be incorporated, the spray device can spray mist having different effects or fragrances at a specific time point to vary spray effects such that the spray device can be applied to a wider field.

### SUMMARY OF THE INVENTION

In view of the shortcomings of the prior art, the inventor(s) of the present invention based on years of experience in the related industry to conduct extensive researches and experiments, and finally developed a programmable spray device that is portable and its spray method as a principle objective to overcome a problem of merely achieving single spray effect through a conventional spray device.

To achieve the foregoing objective of the invention, a programmable spray device that is portable is provided and includes a plurality of spray modules and a control module. Each spray module is respectively filled with different fluids. The control module receives a control signal outputted by a processing device. The control module controls each spray module to perform spraying motion based upon the control signal. The processing module comprises a multimedia play module. When the multimedia play module plays a multimedia content to generate the control signal, the control module controls each spray module to perform spraying variation in accordance with the multimedia content.

Preferably, the plurality of spray modules is movably arranged to a location on the programmable spray device to provide the user access for replacement.

Preferably, each spray module performs spraying motion through ultrasonic vibration or piezoelectric manner.

Preferably, time length of spraying performed by each spray module is controlled by the control module based upon the control signal, and the control module further selects the specific spray module to perform spraying based upon the control signal.

Preferably, the processing device stores a plurality of spraying instructions in advance, and each spraying instruction corresponds to a time point of the multimedia content such that when the control module receives the control signal, each spray module performs spraying motion at each time point of the multimedia content according to the spraying instruction.

Preferably, the processing device is a personal computer, a laptop computer, a smart phone or a tablet computer, and the processing device is electrically connected to the programmable spray device.

To achieve the foregoing objective of the invention, a spray method is provided and applied to a programmable spray device and comprises the following steps: providing a plurality of spray modules and arranging the plurality of spray modules to a location on the programmable spray device side by side; respectively filling each spray module with different fluids; and utilizing a control module to receive a control signal outputted by a processing device to allow the control module to control each spray module performing spraying motion based upon the control signal; wherein the processing device comprises a multimedia play module, and when the multimedia play module plays a multimedia content to generate the control signal, the control module controls each spray module to perform spray variation in accordance with the multimedia content.

The programmable spray device and its spray method according to the invention have one or more advantages as the following:

The programmable spray device and its spray method can be controlled by the computer to allow the programmable spray device to perform different spray variations in compliance with the multimedia content played in the computer, and mist having different colors, fragrance, and water drop sizes. The foregoing feature is different from just repeatedly performing a single spray motion in prior arts.

The programmable spray device arranges the sequence of each spray module side by side in a condition that is similar to an ink-jet printer. Each spray module can movably provided access to the user for replacement and can be more flexibly applied.

### BRIEF DESCRIPTION OF THE DRAWINGS

FIG. 1 is a block diagram of a programmable spray device according to the invention;

FIG. 2 is a flowchart of a spray method of a programmable spray device according to the invention; and

FIG. 3 is a schematic diagram of a programmable spray device and a spray method according to an embodiment of the invention.

### DETAILED DESCRIPTION OF THE PREFERRED EMBODIMENTS

The foregoing and other technical characteristics of the present invention will become apparent with the detailed description of the preferred embodiments and the illustration of the related drawings.

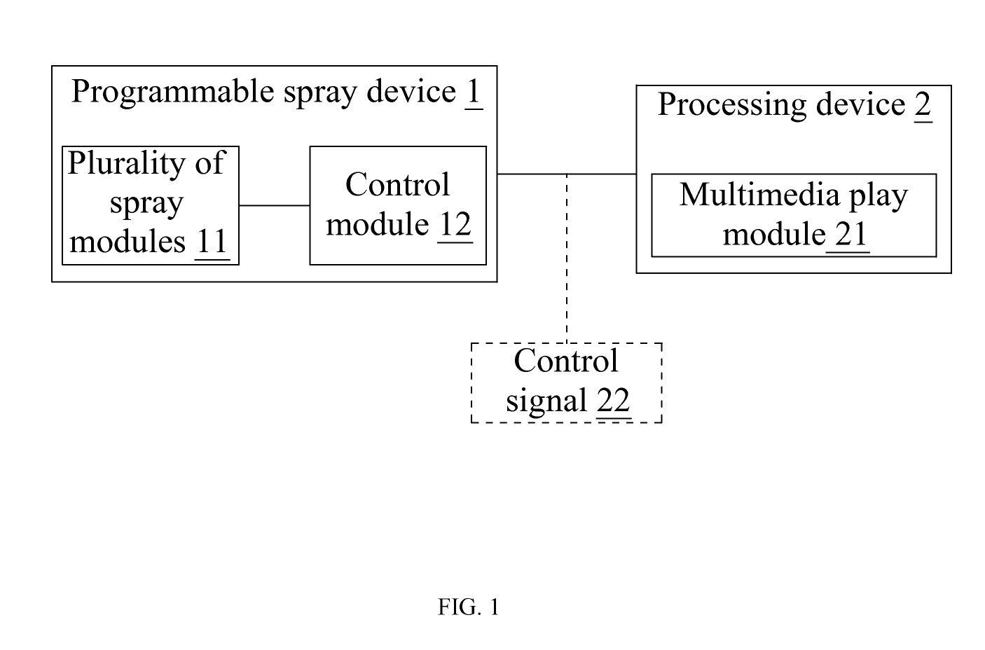

With reference to FIG. 1 for a block diagram of a programmable spray device that is portable according to the invention is depicted. The programmable spray device 1 comprises a plurality of spray modules 11 and a control module 12. The programmable spray device 1 is electrically connected to a processing device 2. The processing device 2 comprises a multimedia play module 21. The appearance style and the size of the programmable spray device 1 can be randomly changed without any restriction. Each spray module 11 is arranged to a location on the programmable spray device 1 side by side as in an ink cartridge of an ink jet printer that is provided for a user to movably replace the spray module 11 or fluid filled within the spray module 11. Styles and types of each spray module 11 are not restricted and can be small type spray guns sold in the market. Each spray module 11 can vibrate the fluid to spray the fluid in mist manner after granulating the fluid. Each spray module 11 can vibrate the fluid through ultrasonic vibration or piezoelectricity manners. The control module 12 can be a control processing chip disposed in the programmable spray device 1. The processing device 2 can be a personal computer, a laptop computer, a smart phone or a tablet computer or other machines for data processing. A multimedia play module 21 can be a multimedia software interface installed in the processing device 2 and can be an independent device from the processing device 2 so as to a separate multimedia player. The programmable spray device 1 can be directly connected to the multimedia module 21 rather than connecting the processing device 2 of various computers.

Each spray module 11 can be respectively filled with organic fluid or inorganic fluid having different fragrance or colors so that when the control module 12 of the programmable spray device 1 receives a control signal 22 transmitted from the processing device 2, each spray module 11 can be controlled by the control signal 22 to perform spray motion so that each spray module 11 sprays mist having different colors or fragrance. Time length of continuously spraying mist from each spray module 11 is controlled by the control module 12 based upon the control signal 22. The control module 12 controls specific spray modules 11 to perform the spray motion based upon the control signal 22. In another words, when the control module 12 receives the control signal 22, all, individual or some specific group of the spray modules 11 can continuously and intermittently perform spraying for long or short periods to alternately allow the motion of each spray module 11 to achieve a rich spray effect.

The user can directly control the spraying of the programmable spray device 1 through a control program in the processing device 2. Alternatively, the user can selectively start the multimedia play module 21 in the processing device 2 to utilize the multimedia play module 21 to control the programmable spray device 1 such that each spray module 11 can perform different spray variation based upon a multimedia content played by the multimedia play module 21. The multimedia content can be music or movies. The processing device 2 can pre-store a plurality of spraying instructions and allows each spraying instruction to correspond to a time point of the multimedia content. When the control module 12 receives the control signal 22 containing these spraying instructions, the control module 12 executes the correspondingly spraying instructions to control all, individual or a specific group of spray modules 11 to perform a spray motion at the corresponding time point of playing the multimedia content such that when the user is watching movies or listening to music, different spraying effects are generated according to the variety of the contents to allow the user to have a more immersed multimedia experience.

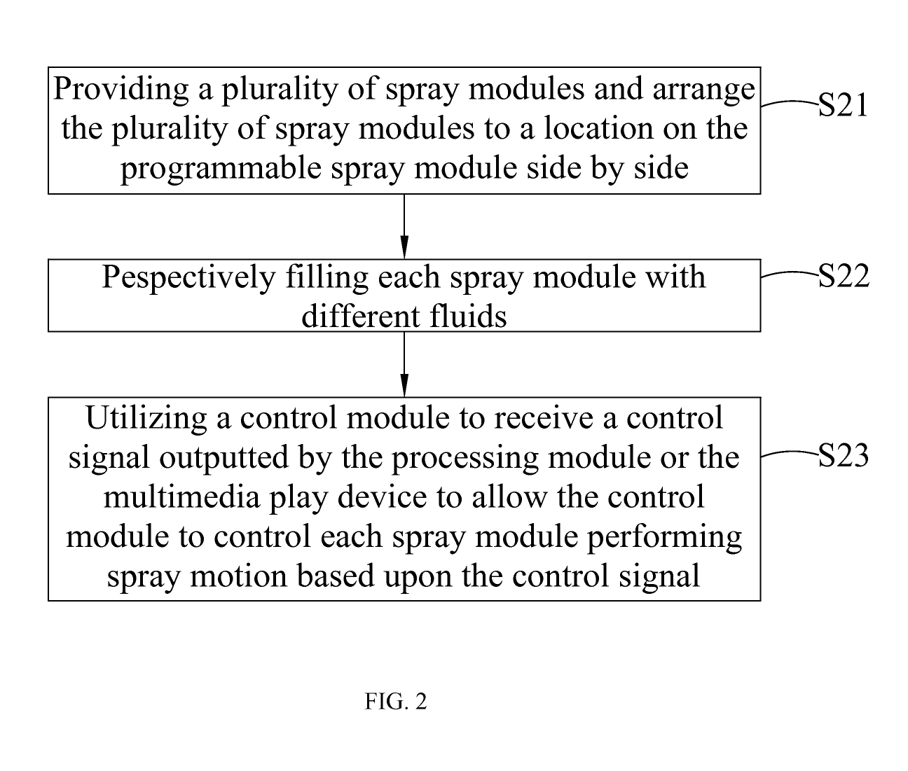

With reference to FIG. 2 for a flowchart of a spray method of a programmable spray device of the invention is depicted. The programmable spray device is connected to a processing device or a multimedia play device. Steps of the spray method include: S21: provide a plurality of spray modules and arrange the plurality of spray modules to a place of the programmable spray module side by side; S22: respectively fill each spray module with different fluids; S23: utilize a control module to receive a control signal outputted by the processing module or the multimedia play device to allow the control module to control each spray module performing spray motion based upon the control signal, wherein if the programmable spray device is connected to the multimedia play device, the programmable spray device can perform spray motion based upon the multimedia content played by the multimedia play device, and the spray effect is diversely based upon different fragrance or colors of the fluids filled in each spray module.

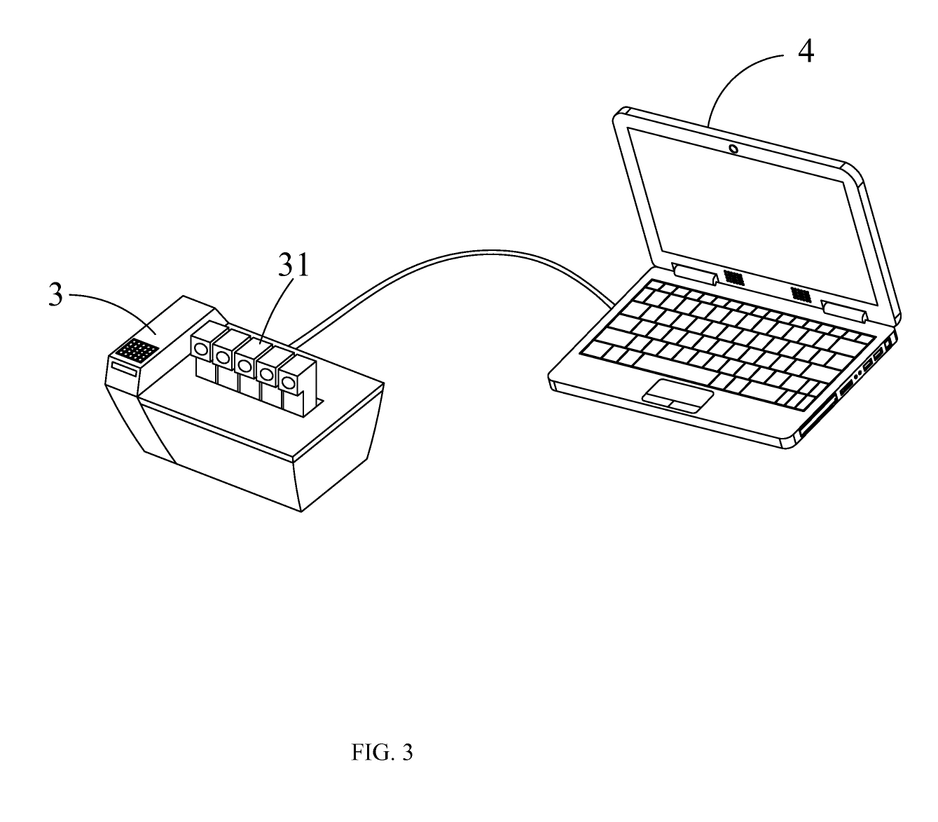

With reference to FIG. 3 for a schematic diagram of a programmable spray device and its spray method of the invention is depicted. The programmable spray device 3 is designed as a small ink jetprinter that comprises a plurality of spray heads 31. The designed style of the programmable spray device 3 is, but not limited to that shown in the embodiment. The programmable spray device 3 can be connected to a laptop computer 4 or connected to a multimedia play device (not shown in the figure) or connected to a device capable of controlling the programmable spray device 3. Programs or software capable of controlling the programmable spray device 3 are installed in the laptop computer 4 to allow the programmable spray device 3 to control each spray head 31 spraying mist having different fragrance or colors through the control of the laptop computer 4. For example, multimedia play software is installed in the laptop computer, and the user can set a multimedia content played by the multimedia play software in advance to preset a spraying instruction for each time point of the multimedia content such that when the user utilizes the multimedia play software to play the multimedia content and the time point of presetting a spraying instruction is reached, the programmable spray device 3 allows all, individual or a specific group of the spray heads 21 to continuously or intermittently perform spraying motion at long or short periods based upon the spraying instruction. For example, when the user utilizes the multimedia play software of the laptop computer 4 to play a “A” movie and the “A” movie is played to one minute and thirty six second of a time point, the content of the “A” movie played at the time point is that a leading role is appreciating flowers in a garden. The spraying instruction preset at one minute and thirty six second of the time point can be commanded to the programmable spray device 3 to allow the spray head 31 to continuously or intermittently spray flower fragrance at one minute and thirty six second such that the user has the feel as though they were in the garden in the garden. Accordingly, when the user is watching or listening to multimedia, better sensory enjoyment can be achieved through a rich and variety of spray effects.

The invention improves over the prior art and complies with patent application requirements, and thus is duly filed for patent application. While the invention has been described by device of specific embodiments, numerous modifications and variations could be made thereto by those generally skilled in the art without departing from the scope and spirit of the invention set forth in the claims.

What is claimed is:

1. A programmable spray device comprising:
a plurality of spray modules, each spray module respectively filled with different fluids; and
a control module for receiving a control signal outputted by a processing device, the control module controlling each spray module to perform spraying motion based upon the control signal;
wherein the processing device comprises a multimedia play module, and when the multimedia play module plays a multimedia content to generate the control signal, the control module controls each spray module to perform spray variation in accordance with the multimedia content.

2. The programmable spray device as recited in claim 1, wherein the spray modules are movably arranged to a location on the programmable spray device side by side to provide a user access for replacement.

3. The programmable spray device as recited in claim 1, wherein each spray module performs spraying motion through ultrasonic vibration or piezoelectric manner.

4. The programmable spray device as recited in claim 1, wherein time length of spraying performed by each spray module is controlled by the control module based upon the control signal, and the control module further selects the specific spray module to perform spraying based upon the control signal.

5. The programmable spray device as recited in claim 1, wherein the processing device stores a plurality of spraying instructions in advance, and each spraying instruction corresponds to a time point of the multimedia content such that when the control module receives the control signal, each spray module performs spraying motion at each time point of the multimedia content according to the spraying instruction.

6. The programmable spray device as recited in claim 1, wherein the processing device is a personal computer, a laptop computer, a smart phone or a tablet computer, and the processing device is electrically connected to the programmable spray device.

7. A spray method applied to a programmable spray device, the method comprising:
providing a plurality of spray modules and arranging the plurality of spray modules to a location on the programmable spray device side by side;
respectively filling each spray module with different fluids; and
utilizing a control module to receive a control signal outputted by a processing device to allow the control module to control each spray module performing spraying motion based upon the control signal;
wherein the processing device comprises a multimedia play module, and when the multimedia play module plays a multimedia content to generate the control signal, the control module controls each spray module to perform spray variation in accordance with the multimedia content.

8. The spray method as recited in claim 7, wherein each spray module performs spraying motion through ultrasonic vibration or piezoelectric manner.

9. The spray method as recited in claim 7, wherein time length of spraying performed by each spray module is controlled by the control module based upon the control signal, and the control module further selects the specific spray module to perform spraying based upon the control signal.

10. The spray method as recited in claim 7, wherein the processing device stores a plurality of spraying instructions in advance, and each spraying instruction corresponds to a time point of the multimedia content such that when the control module receives the control signal, each spray module performs spraying motion at each time point of the multimedia content according to the spraying instruction.

11. The spray method as recited in claim 7, wherein the processing device is a personal computer, a laptop computer, a smart phone or a tablet computer, and the processing device is electrically connected to the programmable spray device.
